(19) United States
(12) Patent Application Publication
(10) Pub. No.: US 2016/0099474 A1
(43) Pub. Date: Apr. 7, 2016

(54) Electrochemical Devices For Use In Extreme Conditions

(71) Applicant: SCHLUMBERGER TECHNOLOGY CORPORATION, Sugar Land, TX (US)

(72) Inventors: Wenlin Zhang, Shanghai (CN); Richard Frerker, Cheltenham (GB); Iain Michael Cooper, Sugar Land, TX (US); Catherine Danielle Busser, Le Plessis Robinson (FR); Arunkumar Tiruvannamalai, Monrovia, CA (US); Hsu-Feng Cheng, Arcadia, CA (US); Joseph Ralph Wong, South Pasadena, CA (US); Simon Jones, Los Angeles, CA (US)

(21) Appl. No.: 14/967,451

(22) Filed: Dec. 14, 2015

Related U.S. Application Data
(63) Continuation of application No. 13/080,993, filed on Apr. 6, 2011.
(60) Provisional application No. 61/321,309, filed on Apr. 6, 2010.

(51) Int. Cl. H01M 6/16; H01M 4/583; H01M 4/38

(52) U.S. Cl. CPC H01M 6/164; H01M 4/382; H01M 4/5835; H01M 6/166; H01M 2300/0028; H01M 2220/00

(57) ABSTRACT

An electrochemical device, such as a battery or power source, provides improved performance under stringent or extreme conditions. Such an electrochemical device for use in high temperature conditions may include at least a cathode, a lithium-based anode, a separator, and an ionic liquid electrolyte. This device also may include a current collector and housing that are electrochemically inert with respect to other components of the device. This electrochemical device may operate at temperatures ranging from 0 to 180, 200, 220, 240, and 260° C.

### CROSS REFERENCE TO RELATED APPLICATION

This application is a continuation of U.S. patent application Ser. No. 13/080,993 filed Apr. 6, 2011, which claims priority to U.S. Provisional Application No. 61/321,309, filed on Apr. 6, 2010, the entire contents of which are hereby incorporated by reference herein.

### FIELD OF THE INVENTION

The disclosure relates generally to electrochemical devices that convert chemical energy to electrochemical current, and more specifically, to an electrochemical device that may be employed under extreme conditions.

### BACKGROUND

Increasing worldwide energy demands as well as depletion of more easily accessible oilfield reservoirs have pushed exploration to more harsh or extreme environments, such as deepwater, and geothermal energy drilling is now occurring. These harsh environments generally involve high pressure and/or high temperature conditions. These high pressure and/or high temperature conditions often impose more stringent demands for devices powering downhole equipment. In the past, lithium thionyl chloride (LiSOCl₂) batteries have been a power source widely used in oilfield downhole exploration. However, LiSOCl₂ batteries are intrinsically unstable at high temperatures given the low melting temperature of lithium, and these physical properties tend to limit the operational temperature of LiSOCl₂ batteries to a maximum of 200° C. Exceeding these limits with a LiSOCl₂ battery may result in battery malfunction, performance degradation, and potential battery explosion.

### SUMMARY

Embodiments of the present disclosure generally provide an electrochemical device for use in high temperature conditions, the device comprising at least a cathode, a lithium-based anode, an ionic liquid electrolyte, and a separator, wherein the device operates at temperatures ranging from approximately 0 to 180, 200, 220, 240, or 260° C. The cathode may be fluorinated carbon having a formula of CFₓ wherein x is in the range of 0.3 to 1. The fluorinated carbon may be formed without surfactants. Alternatively, the cathode may be comprised of MnO₂ or FeS₂. The lithium-based anode may be selected from the group comprising lithium, a binary alloy having the formula LiₓM_{y}, a binary alloy having the formula Liₓ₋₁Mₓ, and ingot alloys of Li—B—Mg or Li—Mg—xM, where M is magnesium, silicon, aluminum, tin, boron, calcium, or combinations thereof. The ionic liquid electrolyte may be formed by dissolving a lithium salt in an ionic liquid selected from the group comprising EMI, MPP, BMP, BTMA, DEMMoEA, a hybrid electrolyte, and mixtures thereof. A separator may be selected from at least one material from the group comprising fiberglass, PTFE, polyimide, alumina, silica, and zirconia.

This electrochemical device formed according to embodiments of the present disclosure may comprise a current collector formed from at least one of the following materials: nickel, titanium, stainless steel, aluminum, silver, gold, platinum, carbon cloth, and carbon-coated titanium or stainless steel. The cathode also may be pressed onto foam or mesh to form a current collector. This electrochemical device also may be comprised of a housing formed from at least one of the following materials: stainless steel, high nickel stainless steel, titanium, noble metal plated stainless steel, and non-metal coated stainless steel. Alternatively, the cathode may be directly attached to the housing of the device. The device may have a configuration selected from the group comprising a bobbin structure, a thin layer coating, a spiral wound structure, and a medium-thick layer wrap structure.

Another embodiment of the present disclosure is directed to a high temperature power source comprising a fluorinated carbon cathode, a lithium-based anode, a separator, and an ionic liquid electrolyte, wherein the power source operates at temperatures ranging from approximately 0 to 260° C. The ionic liquid electrolyte may be formed by dissolving a lithium salt in an ionic liquid selected from the group comprising EMI, MPP, BMP, BTMA, DEMMoEA, a hybrid electrolyte, and mixtures thereof. The lithium-based anode may be selected from the group comprising lithium, a binary alloy having the formula LiₓM_{y}, a binary alloy having the formula Liₓ₋₁Mₓ, and ingot alloys of Li—B—Mg and Li—Mg—xM, where M is magnesium, silicon, aluminum, tin, boron, calcium or combinations thereof.

A further embodiment of the present disclosure is directed to a battery for use in high temperature conditions, the battery comprising a subfluorinated carbon cathode, a Li—B—Mg anode with respective weight percentages of 64:32:4, and an ionic liquid electrolyte, wherein the battery operates at temperatures ranging from approximately 0 to 260° C. The subfluorinated carbon may have the formula of CFₓ wherein x has a value of 0.9. The ionic liquid electrolyte may range from 0.1 to 1 M concentration of LiTFSI dissolved in MPP. The battery also may include a separator comprised of two layers of materials selected from the group comprising polyimide, PTFE, porous ceramic such alumina, silica or zirconia, or fiberglass, and combinations thereof. The battery may further comprise a mesh current collector formed from nickel, stainless steel, aluminum, silver, gold, titanium, carbon cloth, or carbon-coated stainless steel or titanium.

### BRIEF DESCRIPTION OF THE DRAWINGS

For a more complete understanding of this disclosure and its features, reference is now made to the following description, taking in conjunction with the following drawings, in which:

FIG. 1 depicts x-ray diffraction analysis of CFₓ cathode material after high-temperature exposure in contact with carbon-coated titanium according to an embodiment of the present disclosure;

FIG. 2 depicts x-ray diffraction analysis of CFₓ cathode material after high-temperature exposure in contact with stainless steel 316 according to an embodiment of the present disclosure;

FIG. 3 depicts x-ray diffraction analysis of CFₓ cathode material after high-temperature exposure in contact with nickel alloy 625 according to an embodiment of the present disclosure;

FIG. 4 depicts differential scanning calorimetry (DSC) analysis for anodes according to embodiments of the present disclosure;

FIG. 5 depicts thermo gravimetry analysis (TGA) curves for ionic liquid electrolytes according to embodiments of the present disclosure;

FIG. 6 depicts DSC analysis of various ionic liquid electrolytes according to embodiments of the present disclosure;

FIG. 7 depicts DSC analysis of CFₓ cathode/electrolyte half-cell configurations for various ionic liquid electrolytes according to embodiments of the present disclosure;

FIG. 8 depicts DSC analysis of lithium-based anode/electrolyte half-cell configurations for various ionic liquid electrolytes according to embodiments of the present disclosure;

FIG. 9 depicts discharge curves of a high-temperature battery formed according to an embodiment of the present disclosure; and

FIG. 10 depicts a voltage profile of a high-temperature battery according to an embodiment of the present disclosure.

### DETAILED DESCRIPTION

Functional battery chemistry is based on electrochemical coupling with a certain electromotive force (emf) to drive current flow in the battery. A battery involves at least one electrochemical reaction that occurs across the interface between the electrodes and their common electrolyte during discharge. Accordingly, the components of an electrochemical device need to be compatible with one another. For high temperature conditions, such as those that may occur in oilfield subsurface exploration and production operations, the device components also should be thermally stable when exposed to extreme conditions. Other components of an electrochemical device, such as the cell housing and the current collector, also need to be constructed to withstand these extreme conditions.

Embodiments of the present disclosure provide an electrochemical device, such as a battery or power source, that converts chemical energy to electrochemical current, and may provide improved performance under stringent or extreme conditions, including high temperature. The device may comprise at least a cathode, i.e., a positive electrode comprised of subfluorinated carbon or carbon monofluoride; an anode, i.e., a negative electrode; and an ionic liquid electrolyte. The device also may include a current collector as well as a housing comprised of a material that is electrochemically inert with respect to the other components of the device. The device also should include a separator, which may physically and electrically isolate the two electrodes while allowing ionic current to flow across the electrodes.

The different device components—anode, cathode, electrolyte, current collector, separator, and cell housing—may be formed from materials that allow reliable energy supply across a wide operating temperature range. More specifically, the materials forming an electrochemical device according to embodiments of the present disclosure may be constructed to operate at temperatures at or above 200° C., which is approximately the current operational limit of lithium thionyl chloride (LTC) batteries.

Turning to the cathode component of electrochemical devices formed according to embodiments of the present disclosure, a solid-state cathode, such as subfluorinated carbon or carbon monofluoride, may be employed in extreme high temperature conditions. These types of cathode materials may be synthesized at temperatures of approximately 350-600° C. As such, they are chemically stable and should not thermally decompose at higher temperature ranges.

Subfluorinated carbon is a carbon-fluorine intercalation compound having an overall formula of CFₓ, wherein x ranges from approximately 0.3 to 1. Fluorination numbers within this range may ensure good conductivity of the cathode and increase the power density of the cathode material. Higher fluorination numbers within this range, such as 0.9 or higher, may be utilized to support high capacity/low rate applications. However, lower fluorination numbers within this range also may be used to obtain high operating voltages with no voltage delay at the beginning of discharge.

A fluorinated carbon cathode material may be produced using an array of possible precursor materials, including but not necessarily limited to, active carbon, nano carbon, and graphite. The precursor material may generally have a small particle size to provide greater surface area and to allow the material to be packed into higher density configurations. This greater surface area and higher density configuration also may encourage higher power and higher energy use.

Further, cathodes according to embodiments of the present disclosure generally may be formed without components other than a solvent, such as water and/or isopropyl alcohol, a binder, and Super P (carbon). This is a departure from conventional cathode formation methods that utilize additives, such as surfactants. In an embodiment of the present disclosure, the cathode may be formed as CFₓ/carbon/binder with respective weight percentages of 85/10/5.

Further, it should be appreciated that materials other than carbon monofluoride and subfluorinated carbon may be used as the cathode component of an electrochemical device formed according to embodiments of the present disclosure. Alternative cathode materials may include MnO₂ and FeS₂ and combinations thereof. MnO₂ has been evaluated and performs well at a temperature range of approximately 100-150° C. based on DSC analysis. FeS₂ also exhibits similar properties and behavior to MnO₂.

A current collector may be utilized to improve cathode utilization according to embodiments of the present disclosure. For example, the selected cathode material may be pressed onto metal foam or mesh formed from materials including, but not necessarily limited to, nickel, titanium, aluminum, noble metals such as silver, gold, or platinum, carbon cloth, stainless steel, and carbon-coated stainless steel.

Foam may afford more surface area contact in relation to the cathode material. This increased surface area may improve both adhesion of the cathode material to the substrate as well as electrical conduction through the cathode material. While mesh may have less surface contact area in relation to the cathode material as compared to foam, it still may provide a similar rate capability and a similar capacity as compared to foam. Use of a non-metal current collector and/or inclusion of carbon coating on a current collector may enhance corrosion resistance to avoid potential corrosion issues that could result in shorts in the device when in use.

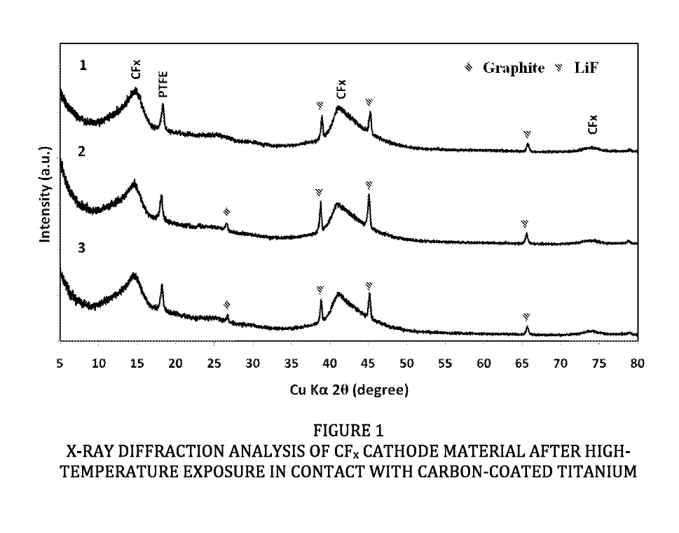

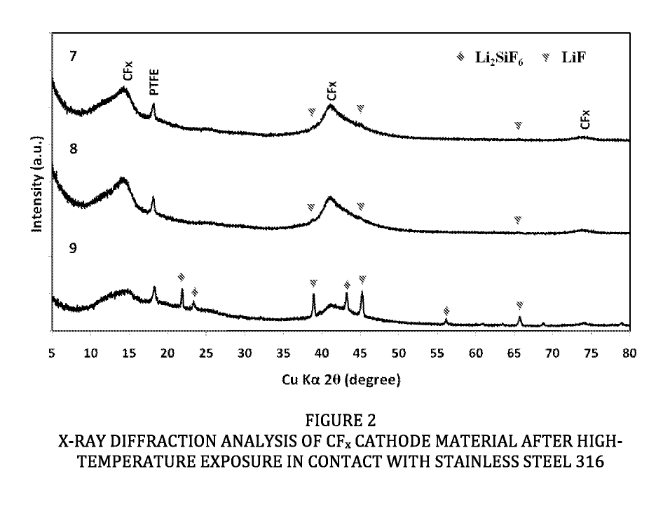

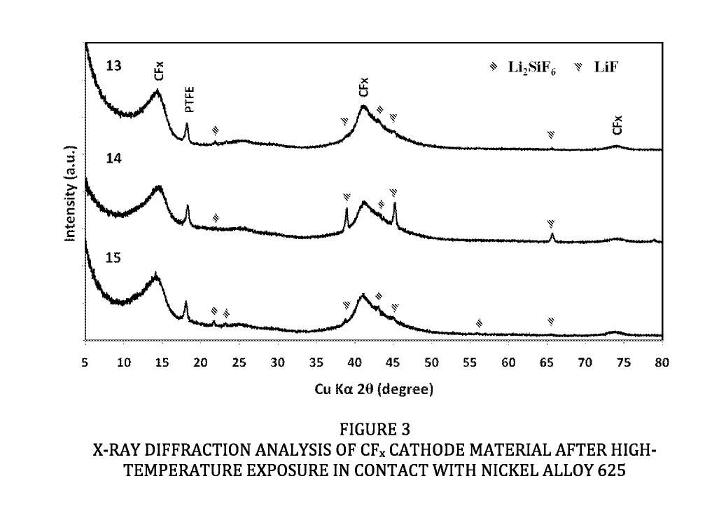

The effectiveness of various current collectors was evaluated using X-ray diffraction cathode analysis. Cathode samples were maintained at 220° C. for 150 hours in contact with different current collector materials, and then the cathode was analyzed using X-ray diffraction. FIGS. 1-3 depict x-ray diffraction analysis of CFₓ cathode material after high-temperature exposure in contact with carbon-coated titanium, stainless steel 316, and nickel alloy 625, respectively. These results are depicted as intensity (a.u.) relative to Cu Kα 2θ (degree). These x-ray diffraction results reveal that carbon-coated titanium, stainless steel 316, and nickel alloy 625 may be effective current collectors. These materials are relatively stable against corrosion under the test conditions as no corrosion by-products were identified and the CFₓ content remained the same. However, it should be appreciated that other materials including, but not necessarily limited to, aluminum, nickel, titanium, silver, gold, platinum, stainless steel, carbon cloth, and carbon-coated stainless steel or titanium may be used as current collectors without departing from the present disclosure.

In some embodiments of the present disclosure, however, the cathode material may be directly attached to the device housing in order to obviate the need for a current collector. This direct attachment also may dissipate reaction heat that may be generated during discharge.

Turning to the anode component of devices formed according to embodiments of the present disclosure, in the past, pure lithium has generally been utilized as an anode for LiSOCl₂ batteries. However, because pure lithium has a melting temperature of approximately 180° C., incorporating pure lithium into a device formed according to embodiments of the present disclosure may limit device operation to a maximum temperature of approximately 175° C. Although embodiments of the present disclosure comprised of pure lithium as an anode may function well up to 175° C., this may lead to poor performance for such a device when exposed to extreme conditions.

The anode according to embodiments of the present disclosure may be comprised of a material with increased thermal stability at higher temperatures although the material may reduce the emf of such an electrochemical system. In some embodiments, lithium may be alloyed with secondary elements, such as calcium, aluminum, zinc and magnesium. These lithium-based alloy materials may be stable at temperatures around approximately 260° C. Such lithium alloys may release lithium ions during discharge but do not physically melt at high temperatures.

Pure lithium or various lithium alloys may be utilized in devices formed according to embodiments of the present disclosure. Alloys may include non-solution binary lithium alloys where pure lithium may be contained in a structural matrix of Li(ₓ)M(_{y}) or Li₁₋ₓMₓ, and M may represent magnesium, silicon, aluminum, tin, boron, calcium, zinc, or combinations thereof. For example, lithium-magnesium may be used as a lithium binary alloy for higher temperature batteries. The secondary element contents of such alloys may vary from 1-25 weight percent depending on the upper temperature limit desired and the related discharge load profiles. However, in order to raise the melting temperature of the anode to a higher value (such as at or above approximately 210° C.), larger amounts of magnesium may need to be incorporated into the alloy. These larger amounts of magnesium may cause the alloy to be harder and brittle, and accordingly may present more complication in anode formulation and more difficulty in battery assembly and manufacturing. The formulated composite anode from alloy particle powders also may enhance the unstable features at high temperature due to having a higher surface area. Therefore, although more conventional binary lithium alloys with higher amounts of the second element may be used as anodes according to embodiments of the present disclosure, in certain scenarios, ingot lithium alloys may be used in place of the above-referenced binary lithium alloys for ease in assembly and manufacturing as well as for maintaining higher thermal stability and electrochemical functionality. Such ingot lithium alloys may include, Li—B—Mg or Li—Mg—xM, where M may represent silicon, aluminum, tin, boron, calcium, zinc or combinations thereof

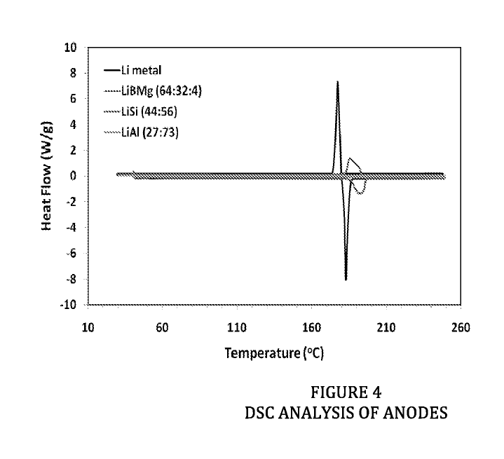

Various binary and ingot lithium alloys, including Li—Mg, Li—B—Mg, Li—B, Li—Si, and Li—Al, were evaluated with respect to pure lithium using differential scanning calorimetry (DSC). FIG. 4 depicts results of DSC analysis in heat flow (W/g) relative to temperature for pure lithium metal, Li—B—Mg (with respective weight percentages of 64:32:4), Li—Si (with respective weight percentages of 44:56), and Li—Al (with respective weight percentages of 27:73) over a temperature range from room temperature up to approximately 260° C. Pure lithium shows an expected endothermic peak at approximately 180° C. when evaluated over this temperature range. Li—Al and Li—Si were found not to melt at the maximum of this temperature range. Li—B—Mg and Li—B also show an endothermic peak at approximately 180-190° C., demonstrating depressed thermal behaviors corresponding to the melting of the pure lithium metal trapped in the higher melting point alloy matrix.

Turning to electrolytes to be incorporated as part of devices formed according to embodiments of the present disclosure, organic electrolytes have been used in some commercial batteries, but they have proven to be unsuitable for use in electrochemical devices to be operated in extreme conditions. A device formed according to embodiments of the present disclosure therefore may incorporate non-volatile ionic liquid electrolytes to substantially expand the temperature range of the device for use in high temperature applications. Ionic liquid electrolytes are chemically stable and generally chemically compatible with both the cathode material as well as the anode material over the operating temperature range. They also are generally thermally stable at high temperature, and they generally have very low vapor pressure. Further, devices incorporating ionic liquid electrolytes generally maintain certain ionic conductivity in the operational temperature range.

A lithium salt, such as Li-TFSI, may be dissolved in one of several ionic liquids, where the salt has a concentration of 0.1 to 1.0 M, to form ionic liquid electrolytes according to embodiments of the present disclosure. Examples of ionic liquids that may be used according to embodiments of the present disclosure include, but are not necessarily limited to, EMI [1-Ethyl-3-methylimidazolium bis(trifluoromethylsulfonyl)imide], MPP [1-Methyl-1-propylpiperidinium bis(trifluoromethylsulfonyl)imide], BMP [1-Butyl-1-methylpyrrolidinium bis(trifluoromethylsulfonyl)imide], BTMA [Butyltrimethylammonium bis(trifluormethylsulfonyl)imide], DEMMoEA (Diethylmethyl (methoxyethyl)ammonium bis(trifluoromethylsulfonyl)imide], other ionic liquids having similar properties, and combinations thereof.

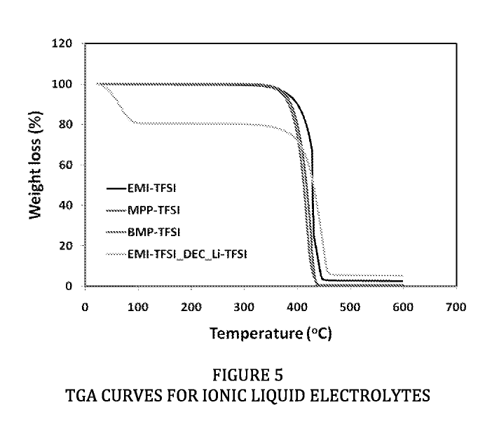

Each of the above-mentioned ionic liquid electrolytes was evaluated using thermo gravimetry analysis (TGA) for weight loss by percentage scanning from room temperature to a temperature of approximately 260° C. FIG. 5 depicts TGA data from room temperature to approximately 400° C. for various ionic liquid electrolytes formed by dissolving a lithium salt in including EMI, MPP, BMP, and EMI mixed with DEC. The various electrolytes were found to be thermally stable up to about 350° C. with minimum weight losses. EMI mixed with approximately 20 weight percent DEC resulted in vaporization of the organic electrolyte when heated up to approximately 100° C., while the residual EMI maintained its stability across the test operating temperature range.

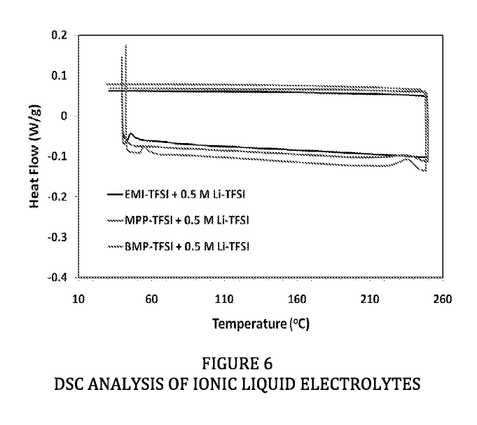

Differential scanning calorimetry (DSC) also was performed to evaluate various ionic liquid electrolytes over a range of temperatures (from room temperature up to approximately 260° C.). Turning to FIG. 6, FIG. 6 depicts DSC analysis results in terms of heat flow (W/g) relative to temperature for ionic liquid electrolytes formed by dissolving a lithium salt in EMI, MPP and BMP; however, no significant reaction was identified within the temperature range of interest. Rather, DSC data depicted in FIG. 6 demonstrates that there are substantially no thermal changes associated with either decomposition or the chemical reaction for these ionic liquid electrolytes.

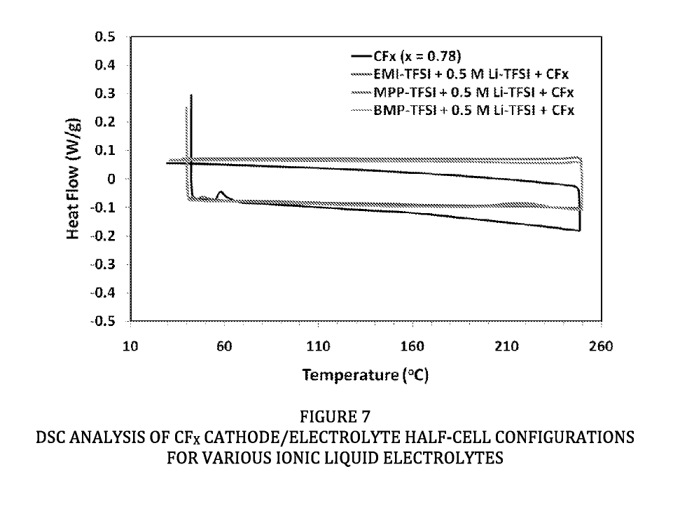

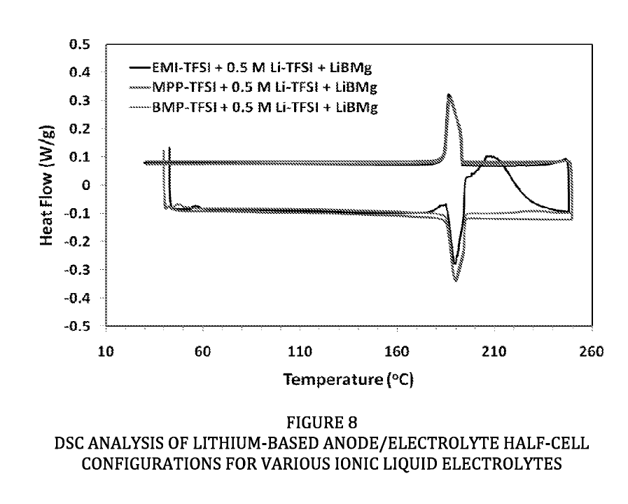

The various ionic liquid electrolytes also were tested in the presence of selected cathode and anode components. These tests entailed placing a small piece of solid anode material or cathode material separately into an electrolyte solution. The individual cathode/electrolyte and anode/electrolyte mixtures were then subjected to DSC experimental scanning. FIGS. 7 and 8 depict DSC analysis of CFₓ cathode/electrolyte and lithium-based anode/electrolyte half-cell configurations for various ionic liquid electrolytes. The various ionic liquid electrolytes were found to have good compatibility with the selected cathode and anode materials. For example, the various anode materials were found not to show excessive reactivity in the presence of ionic liquid electrolytes.

In another embodiment of the present disclosure, a hybrid electrolyte comprised of a mix of ionic liquid and organic electrolyte may be employed to further extend the operating temperature range. The ionic liquid fraction of such a hybrid electrolyte may comprise approximately 50-99% of the resultant composition.

Turning to the device housing to be incorporated as part of devices formed according to embodiments of the present disclosure, the device housing may be constructed from one or more materials, including, but not necessarily limited to, stainless steel, high nickel stainless steel, titanium, non-metal coated stainless steel, noble plated stainless steel, or other materials that are electrochemically inert with respect to the other components of the device. Such a housing may provide a hermetic case for the device across the operating temperature range.

The device structure may comprise one of several configurations, including, but not necessarily limited to, a bobbin structure, a thin layer coating, a spiral wound structure and/or a medium-thick layer wrap structure. A spiral wound structure provides a higher metal exposure area and higher anode/cathode interface area, resulting in possible higher self-discharge in high-temperature electrochemical devices. A spiral wound structure also may comprise more inactive components as compared to a bobbin construction, which may result in lower energy density for the device.

A separator may be used in embodiments of the present disclosure to separate the cell components (anode, cathode, and electrolyte) in the device. The separator is generally thermally stable and chemically compatible with the other components in the operational temperature range. In addition, the separator should have good dielectric performance with higher electrical insulation as well as liquid permeability and ionic transmission. A separator according to embodiments of the present disclosure may include, but is not necessarily limited to, fiberglass, PTFE, polyimide, and porous ceramic, such as alumina, silica or zirconia. A combination of two separators also may be incorporated into a device according to embodiments of the present disclosure. As an example, PTFE may be incompatible with lithium or lithium alloy, and accordingly, a second separator may be used facing the anode while PTFE may be used facing the cathode.

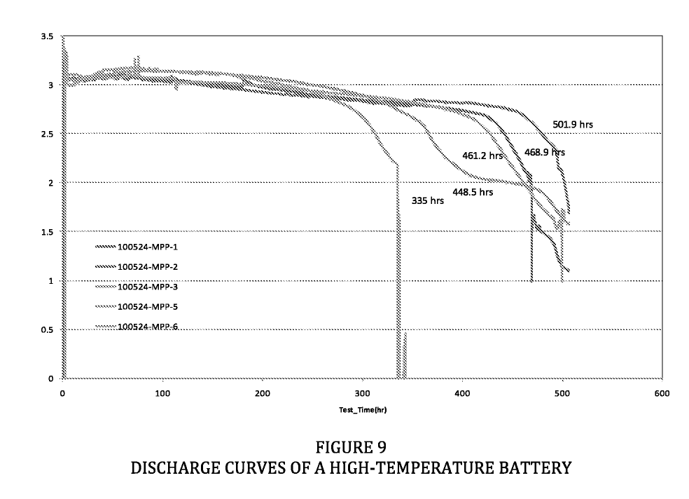

An embodiment of the present disclosure is directed to a battery that may be used at high temperatures. Such a battery may include a CFₓ cathode having an x value of approximately 0.9, and a Li—B—Mg anode with respective weight percentages of 64:32:4. An ionic liquid electrolyte consisting of 0.5 M lithium bis(trifluoromethanesulfony-1)imide (LiTFSI) dissolved in MPP may be used in this embodiment of the present disclosure. The battery also may include a separator comprised of two layers of polyimide, fiberglass, alumina, silica, zirconia, or PTFE having approximately 60% porosity and 39 μm thickness. A mesh current collector may be used, and both the current collector as well as the housing may be comprised of nickel, stainless steel, aluminum, titanium, silver, gold, platinum, carbon cloth, or carbon-coated stainless steel or titanium. As shown in FIG. 9, a battery formed according to this embodiment may provide a run time of approximately 300-400 hours at 2.0V cutoff with an average cathode utilization of approximately 89%. It should be appreciated however that the run time may be lower at room temperature (in a range of 5-15 hours) with a lower discharge rate due to factors such as poor electrode wettability with the ionic liquid electrolyte due to high viscosity at room temperature and non-optimized electrode formation.

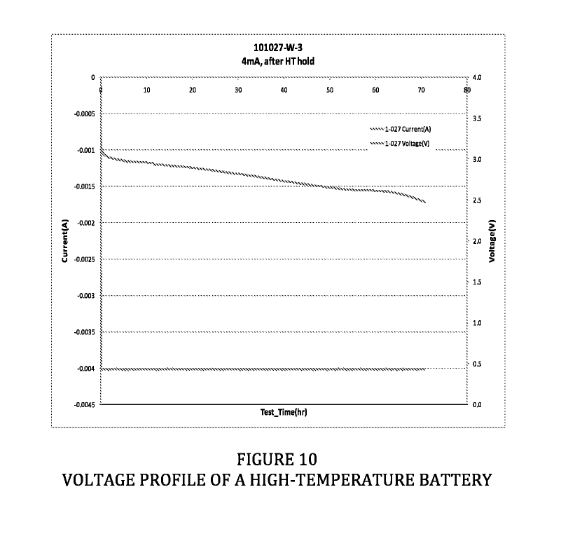

FIG. 10 depicts a voltage profile of a high-temperature battery running at 225° C. according to an embodiment of the present disclosure. In this test, the battery was exposed to the same temperature for approximately 350 hours at open circuit conditions prior to the discharge. The exposure was stopped at the cut-off voltage of 2.5 volts. This discharge profile displays excellent voltage behaviors with no passivation or associated voltage delay effects that have been problems in lithium thionyl chloride battery chemistry.

A battery or device formed according to embodiments of the present disclosure may operate over a wide temperature range from sub-zero ° C. to some of the highest temperatures that may be needed to power oil/gas exploration and production tools traveling from the surface of the well bore through the borehole of the well. This device also may operate over the maximum temperature zone for telemetry communications relays mounted at various depths and multilaterals of oil/gas well deployment. Devices formed using battery chemistry according to embodiments of the present disclosure also may be suitable for long-term installation for well monitoring, drilling and measurements, testing, and other oilfield applications. These devices provide superior performance compared to batteries formed with standard lithium thionyl chloride chemistry and with no trade-offs in high volumetric density, wide operation temperature, or user-friendly operation.

Electrochemical devices formed according to embodiments of the present disclosure also may be used in applications outside of the oilfield industry including, but not necessarily limited to, aerospace, space exploration, automotive tire pressure monitoring, medical, and military defense applications. For example, a high temperature battery formed according to embodiments of the present disclosure may serve to replace the existing LiMnO₂ battery often used for tire pressure monitoring.

Although the present disclosure has been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method of powering a downhole operation, comprising:
powering a downhole operation with an electrochemical device, said electrochemical device comprising:
a cathode;
a lithium-based anode;
an ionic liquid electrolyte formed by dissolving a lithium salt in an ionic liquid; and
a separator;
wherein the electrochemical device operates at least at temperatures ranging from 180° C. to 200° C.

2. The method of claim 1, wherein the ionic liquid is selected from the group consisting of 1-methyl-1-propylpiperidinium bis(trifluoromethylsulfonyl)imide, 1-butyl-1-methylpyrrolidinium bis(trifluoromethylsulfonyl) imide, and mixtures thereof.

3. The method of claim 1, wherein said ionic liquid electrolyte ranges from 0.1 to 1.0 M lithium bis(trifluoromethylsulfonyl)imide concentration dissolved in 1-methyl-1-propylpiperidinium bis(trifluoromethylsulfonyl)imide.

4. The method of claim 1, wherein said cathode is formed from fluorinated carbon having a formula of CFₓ wherein x is in the range of 0.3 to 1.

5. The method of claim 4, wherein said fluorinated carbon cathode is formed without surfactants.

6. The method of claim 1, wherein said electrochemical device further comprising a current collector formed from at least one of the following materials: stainless steel 316, silver, gold, platinum, carbon cloth, carbon-coated titanium, noble metal plated stainless steel, and carbon-coated stainless steel.

7. The method of claim 1, wherein said cathode is pressed onto foam or mesh to form a current collector.

8. The method of claim 1, wherein said electrochemical device further comprises:
a housing formed from at least one of the following materials: stainless steel 316, nickel alloy 625, carbon-coated titanium, noble metal plated stainless steel, and non-metal coated stainless steel.

9. The method of claim 7, wherein said cathode is directly attached to said housing.

10. The method of claim 1, wherein said lithium-based anode is selected from the group comprising:
a binary alloy having the formula LiₓM_{y}, a binary alloy having the formula Li₁₋ₓMₓ, and ingot alloys of Li—B—Mg, where M is boron.

11. The method of claim 1, wherein the lithium-based anode is an ingot alloy of Li—B—Mg with respective weight percentages of about 64:32:4.

12. The method of claim 1, wherein the electrochemical device has a configuration selected from the group comprising:
a bobbin structure, a thin layer coating, a spiral wound structure, and a medium-thick layer wrap structure.

13. The method of claim 1, wherein said separator is a polyimide separator.

14. The method of claim 1, wherein the downhole operation is at least one selected from the group comprising:
oil/gas exploration, oil/gas production, telemetry communication relays, well monitoring/measurements, and drilling operations.

15. The method of claim 1, wherein the electrochemical device operates at least at a temperature ranging from 180° C. to 240° C.

16. The method of claim 1, wherein the electrochemical device operates at least at a temperature ranging from 180° C. to 260° C.

17. A method of powering a downhole operation, comprising:
powering a downhole operation with a battery, said battery comprising:
a fluorinated carbon cathode having a formula of CFₓ wherein x is in the range of 0.3 to 1;
a Li—B—Mg alloy or Li—B alloy anode;
an ionic liquid electrolyte formed by dissolving a lithium salt in an ionic liquid selected from the group consisting of 1-methyl-1-propylpiperidinium bis(trifluoromethylsulfonyl)imide, 1-butyl-1-methylpyrrolidinium bis(trifluoromethylsulfonyl) imide, and mixtures thereof; and
a polyimide separator;
wherein the battery operates at least at a temperature ranging from 180° C. to 220° C.

18. The method of claim 17, wherein said ionic liquid electrolyte ranges from 0.1 to 1.0 M lithium bis(trifluoromethylsulfonyl)imide concentration dissolved in 1-methyl-1-propylpiperidinium bis(trifluoromethylsulfonyl)imide.

19. The method of claim 17, wherein said battery further comprising a current collector formed from at least one of the following materials: stainless steel 316, silver, gold, platinum, carbon cloth, carbon-coated titanium, noble metal plated stainless steel, and carbon-coated stainless steel.

20. The method of claim 1, wherein said battery further comprises:
a housing formed from at least one of the following materials: stainless steel 316, nickel alloy 625, carbon-coated titanium, noble metal plated stainless steel, and non-metal coated stainless steel.
